(19) United States
(12) Patent Application Publication
(10) Pub. No.: US 2025/0297640 A1
(43) Pub. Date: Sep. 25, 2025

(54) FERRULE SYSTEM

(71) Applicant: JAMESON, LLC, Clover, SC (US)

(72) Inventors: Carlos Fernando Becerra Alvarado, Charlotte, NC (US); Blake Andrew Tomlinson, Statesville, NC (US)

(21) Appl. No.: 19/231,221

(22) Filed: Jun. 6, 2025

Related U.S. Application Data
(63) Continuation-in-part of application No. 18/523,206, filed on Nov. 29, 2023.
(60) Provisional application No. 63/385,470, filed on Nov. 30, 2022.

(51) Int. Cl. F16C 11/10; B25G 3/38; B26B 1/04; H02G 1/02

(52) U.S. Cl. CPC F16C 11/103; B25G 3/38; H02G 1/02; B26B 1/046

(57) ABSTRACT

A universal ferrule includes: a mounting end having a cylindrical portion for receiving an effector and defining a central longitudinal axis, and a coupling end opposite the mounting end. At the coupling end, a coupling annulus extending perpendicularly and multiple teeth, defining detents therebetween, are arranged around the coupling annulus. The coupling end has a lock hole for receiving a pin of a female ferrule. The coupling end includes a terminus opposite the mounting end, and the coupling annulus may be interrupted by a slot extending from an edge of the terminus to a center of the coupling annulus. The annulus is flush with the tops of the teeth and raised relative to the detents, thus defining a matingly corresponding arrangement for coupling with a hotstick adapter. Alternatively, the coupling end can be inserted into a female ferrule with a lock pin received in the lock hole.

### CROSS-REFERENCE TO RELATED APPLICATIONS

This is a Continuation-in-Part (CIP) of, and claims the benefit of priority of, U.S. non-provisional patent application Ser. No. 18/523,206, filed Nov. 29, 2023, entitled “Ferrule System,” which claims the priority of U.S. Provisional Application No. 63/385,470, filed Nov. 30, 2022, entitled “Ferrule System,” the entirety of each which is hereby incorporated by reference.

### TECHNICAL FIELD

The present disclosure relates to connectors for joining rods and posts at their ends. More particularly, the present disclosure relates to an improved ferrule system.

### BACKGROUND

Ferrule systems, having male and female components, are used to couple host structures such as posts, rods, tools, and other items to which the male and female components are respectively mounted. Ferrules are used for their convenience, and thus should be intuitively used and should work with some degree of autonomy once a mating pair is brought into contact for engagement, particularly in applications where a user is multi-tasking or cannot reach the junction of the two parts with both hands.

By nature of their work, utility linemen have a need to reach things that are elevated. For example, they may need to reach a transformer up on a post to turn it on/off, or just move or secure electrical lines. They use what is commonly called “hotsticks” for these purposes, which are basically long poles with special electrical characteristics, such as being electrically non-conducting. These “hotsticks” can accept a large variety of tools attached to the end, so that all sorts of specifics tasks can be performed efficiently.

Arborists similarly need to reach and effect elevated structures, such as tree limbs, vines, and in some cases, wires and other implements and installations on trees and other plant structures under their care. Arborists' tools use ferrules to join subsequent pole sections and end tools. Thus, linemen and arborists share some needs for equipment, despite that currently most equipment is dedicated to one line of work or other. Nonetheless, line-clearance professionals have a need for arborists' tools so that they can clear vegetation around electrical power lines, and also have a need for linemen tools, so they can service electrical lines. For this reason, these professionals usually have a need for tools from both industry standards and may carry both hotsticks and other poles in their trucks.

The poles/ferrules system mostly used by arborists, and the “hotstick” system mostly used by linemen have different geometries and are therefore incompatible with each other, rendering “hotstick” tools impossible to use with poles/ferrules and vice versa, forcing line-clearance professionals and the suppliers that cater to them to double their on-hand inventory. Improved cross-compatibility devices and systems are needed.

### SUMMARY

This summary is provided to briefly introduce concepts that are further described in the following detailed descriptions. This summary is not intended to identify key or essential features of the claimed subject matter, nor is it to be construed as limiting the scope of the claimed subject matter.

A universal ferrule according to at least one embodiment includes: a mounting end having a cylindrical portion for receiving an effector, the cylindrical portion defining a central longitudinal axis; and a coupling end opposite the mounting end. The coupling end includes: a coupling annulus extending perpendicularly to the longitudinal axis; multiple teeth, defining detents therebetween, arranged in a circular arc at least partially around the coupling annulus; and a lock hole for receiving a fastener. The universal ferrule has at least two modes of coupling to a host structure. The coupling end is configured to be inserted in a female ferrule with a lock pin of the female ferrule received in the lock hole. The coupling annulus and multiple teeth are configured to mount on a hotstick adapter for use with a hotstick.

The coupling annulus may be flush with tops of the multiple teeth.

The coupling end may include a terminus opposite the mounting end, and the coupling annulus may be interrupted by a slot extending from an edge of the terminus to a center of the coupling annulus.

The slot may extend longitudinally.

The slot may be perpendicular to the longitudinal axis.

The terminus may include a round forward edge with a uniform radius taken from a center of the coupling annulus to the forward edge.

The male ferrule may further include: a first bulge on a first side of the male ferrule between the coupling annulus and the cylindrical portion; a first lock hole opening at a maximum of the first bulge; a second bulge on a second side of the male ferrule opposite the first side and between the coupling annulus and the cylindrical portion; and a second lock hole opening at a maximum of the second bulge.

The male ferrule may further include an interface connecting the mounting end to the coupling end, the interface being enlarged relative to the coupling end such that the interface serves as an insertion stop when the coupling end is inserted into a female ferrule. The lock hole is positioned at approximately the same distance from the insertion stop as that of the lock pin from a terminal edge of the female ferrule that registers with the insertion stop upon full insertion of the coupling end into the female ferrule.

The mounting end may be circularly cylindrical at an interface connecting the mounting end to the coupling end; and the coupling end may be circularly cylindrical at the interface.

The mounting end proximal the interface may be diametrically enlarged relative to the coupling end proximal the interface, enabling the insertion of a portion of an effector into the mounting end.

The mounting end proximal the interface may be diametrically reduced relative to the coupling end proximal the interface, enabling insertion of the mounting end into a portion of an effector.

The coupling end may include a planed area around the slot on a lateral side opposite the coupling annulus.

An effector may be mounted on the mounting end by way of the cylindrical portion, the effector including at least one hook.

An effector may be mounted on the mounting end by way of the cylindrical portion, the effector having at least one toothed cutting edge.

The above effector examples are non-limiting and non-exhaustive.

A mountable tool, according to at least one embodiment and to which the above examples and options apply as well, includes a male ferrule having a mounting end defining a central longitudinal axis and an effector mounted on the mounting end. The male ferrule further includes a coupling end opposite the mounting end, the coupling end including: a coupling annulus extending perpendicularly to the longitudinal axis; multiple teeth, defining detents therebetween, arranged in a circular arc at least partially around the coupling annulus; and a lock hole for receiving a fastener. The coupling end is configured to be inserted in a female ferrule with a lock pin of the female ferrule received in the lock hole. The coupling annulus and multiple teeth are configured to mount on a hotstick adapter for use with a hotstick.

The effector may include at least one hook.

The effector may include at least one toothed cutting edge.

The above effector examples are non-limiting and non-exhaustive.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 is a perspective view of a ferrule joint system according to at least one embodiment.

FIG. 2 is an exploded perspective view of the ferrule joint system of FIG. 1, showing the male and female ferrules thereof uncoupled.

FIG. 3 is a perspective view of the inventive male ferrule of FIG. 2.

FIG. 4 is a side view of the male ferrule of FIG. 2.

FIG. 5 is a longitudinal end view of the male ferrule of FIG. 2, showing the open end for receiving a tool or equipment post or shank for mounting the ferrule.

FIG. 6 is a longitudinal end view of the male ferrule of FIG. 2, showing the insertion end for coupling with the female ferrule of FIGS. 1-2.

FIG. 7 is a side view of the female ferrule of FIG. 2.

FIG. 8 is an exploded perspective view of the female ferrule of FIGS. 2 and 7.

FIG. 9 is an enlarged side view of a proximal portion of the spring clip, indicated by dashed line 9 in FIG. 7.

FIG. 10 is a side view of a commercially available coupling device.

FIG. 11 is another view of the coupling device of FIG. 10, with a coupling plate thereof shown in plan view.

FIG. 12 is an end view of the coupling end of the coupling device of FIG. 10 taken longitudinally.

FIG. 13 is a perspective view of a mountable tool having an effector and universal ferrule, according to at least one embodiment.

FIG. 14 is another perspective view of the mountable tool of FIG. 13.

FIG. 15 is an elevation view of the mountable tool of FIG. 13, with a coupling annulus thereof shown in plan view.

FIG. 16 is an end view of the coupling end of the mountable tool of FIG. 13 taken longitudinally.

FIG. 17 is an end view of the effector end of the mountable tool of FIG. 13 taken longitudinally.

FIG. 18 is an elevation view of the mountable tool of FIG. 13 mounted on the coupling device of FIG. 10 with the fastener in a loose condition.

FIG. 19 is an elevation view of the mountable tool mounted on the coupling device as in FIG. 18 at a pivoted angle, and coupling device mounted on the female ferrule of FIG. 2.

FIG. 20 is an elevation view of the mountable tool of FIG. 13 mounted on the female ferrule of FIG. 2.

FIG. 21 is an elevation view of a universal ferrule according to at least one embodiment.

FIG. 22 is a perspective view of the universal ferrule of the FIG. 21.

FIG. 23 is lateral side view of the universal ferrule of FIG. 21.

FIG. 24 is another perspective view of the universal ferrule of the FIG. 21.

FIG. 25 is an elevation view of a universal ferrule according to at least one embodiment.

FIG. 26 is a perspective view of the universal ferrule of the FIG. 25.

FIG. 27 is an elevation view of a mountable tool having an effector, according to at least one embodiment, and the universal ferrule of FIG. 21.

FIG. 28 is a perspective view of the mountable tool of FIG. 27.

FIG. 29 is an elevation view of a mountable tool having another effector, according to at least one other embodiment, and the universal ferrule of FIG. 21.

FIG. 30 is a perspective view of the mountable tool of FIG. 29.

FIG. 31 is an elevation view of the mountable tool of FIG. 30 mounted on the coupling device of FIG. 10.

FIG. 32 is an elevation view of the mountable tool of FIG. 29 mounted on the female ferrule of FIG. 2.

FIG. 33 is an elevation view of a mountable tool having another effector, according to at least one other embodiment, and the universal ferrule of FIG. 25, the effector being a stowable cutting tool having a blade shown stowed in a scabbard.

FIG. 34 is an elevation view of the mountable tool in FIG. 33, showing the blade deployed from the scabbard.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

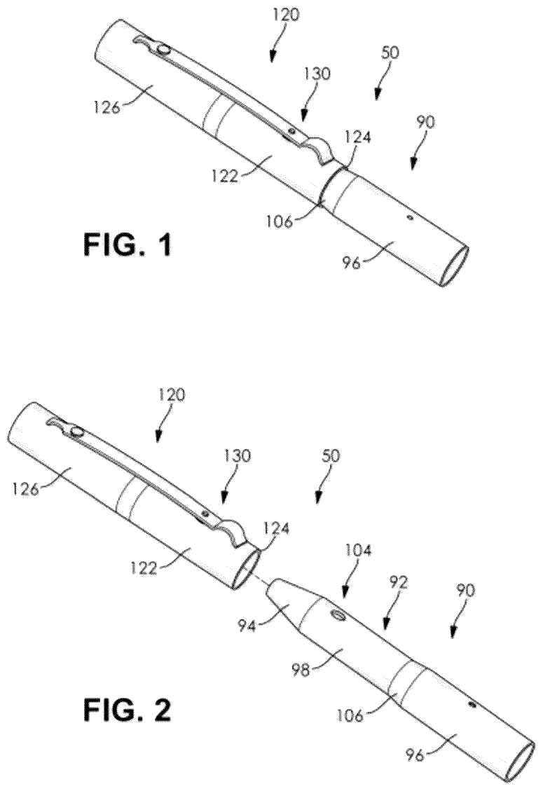

An inventive ferrule joint system 50, according to the embodiment of FIGS. 1-2, provides a releasable locking connection of the two mating parts, termed herein a male ferrule 90 and a female ferrule 120. Each is configured to be mounted on a respective host structure, such as a pole, tool, or other accessory, for use in connecting two structures together by way of the ferrule joint system 50 without requiring expertise or much force to actuate a connection correctly and prevent unintentional disconnection. In use, an insertion end 92 of the male ferrule 90 is manually inserted into the female ferrule 120 and is locked in place by an automatically locking and manually releasable latch 130 including a lock pin 132 (FIG. 9) carried by the female ferrule 120. The lock pin 132 is automatically inserted into a lock hole 104 (FIGS. 2-4) in the male ferrule 90 when their alignment is achieved. Locking is maintained by the latch 130, which exerts enough force so the pin will not be released unintentionally.

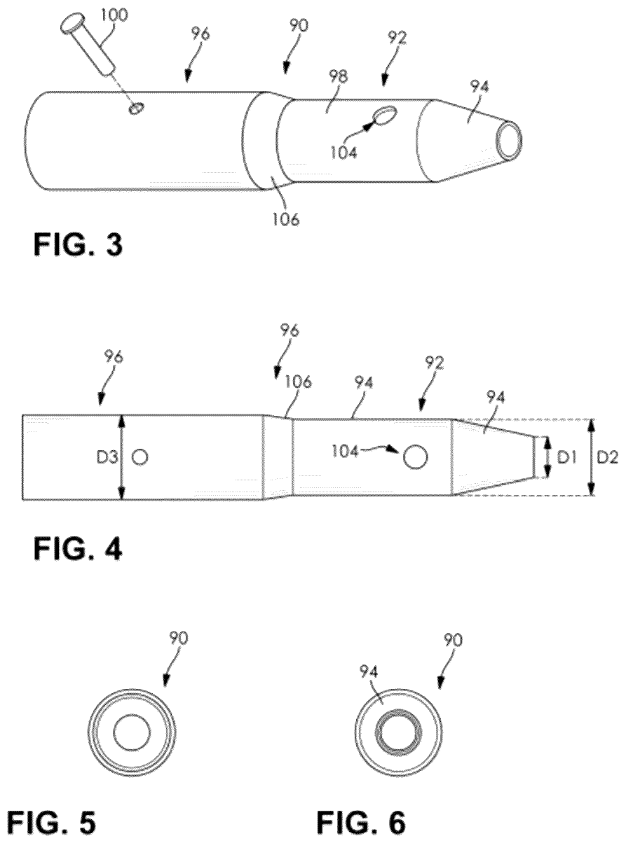

The insertion end 92 of the male ferrule 90 has a frustoconical tapered tip 94 and a cylindrical portion 98. A distal end 96 of the male ferrule opposite the insertion end 92 is cylindrical and diametrically enlarged in relation to a cylindrical portion 98. The distal end 96 receives or is otherwise connected to an end portion of a host structure in use and retained there by a laterally inserted fastener 100 (FIG. 3), illustrated as a bolt or rivet. The cylindrical portion 98 of the insertion end 92 of the male ferrule 90 extends from the tapered tip 94 toward the distal end 96. The cylindrical portion 98 of the insertion end 92 has the lock hole 104 for receiving the lock pin 132 carried by the female ferrule 120. The tapered tip 94 has a small leading edge diameter D1 (FIG. 4) and diametrically increases to the cylindrical portion 98, thus defining an insertion slope. The leading edge diameter D1 is small enough to clear the radially inward end of the locking pin 132 during insertion of the insertion end 92 of the male ferrule 90 into the female ferrule, and the insertion slope of the tapered tip 94 automatically pushes the pin radially outward as the male ferrule advances toward connection. This eliminates the need to manually actuate the latch 130 during insertion.

Additionally, a frustoconical insertion stop 106 is defined intermediate the insertion end 92 and distal end 96. The insertion stop 106 is illustrated as tapered, defining a diametric enlargement from the cylindrical portion 98, which has the greatest diameter D2 of the insertion end 92, to the cylindrical distal end 96, which has the greatest diameter D3 of the male ferrule 90. The lock hole 104 is positioned at approximately the same distance from the insertion stop 106 as that of the clearance hole 140 from the terminal edge 124 of the female ferrule. The clearance hole 140 is at the effective positive position of the locking pin 132. The insertion stop 106 thus prevents the insertion end 92 from being inserted past the alignment plane of the locking pin 132. As a result, alignment of the locking pin 132 and lock hole 104 can be done only in one dimensional adjustment (rotational) once full insertion is achieved by registration of the insertion stop 106 with a terminal proximal edge 124 of the female ferrule 120. This is relatively simple to accomplish because there is a limit to how much the two can be rotated before alignment is achieved (less than a maximum of 360 degrees should align the lock pin with the lock hole).

The female ferrule 120 is illustrated as a generally hollow tubular structure, having a tubular cylindrical distal end 126 for mounting to a host structure in use and retained there by a laterally inserted fastener 136 (FIG. 8), illustrated as a bolt or rivet. Opposite the distal end 126, the female ferrule has a tubular cylindrical proximal end 122, with the terminal proximal edge 124 defining an opening that receives the insertion end 92 of the male ferrule 90 when inserted.

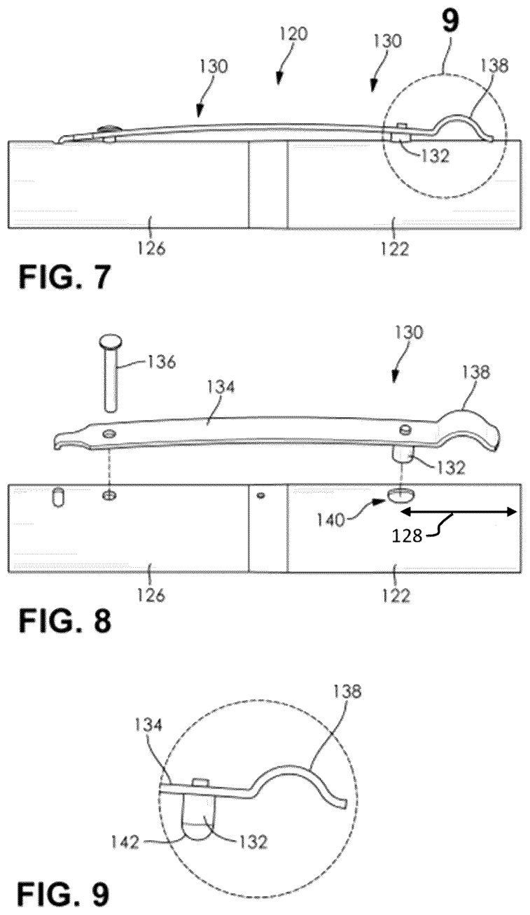

The automatically locking and manually releasable latch 130 including the lock pin 132 (FIGS. 7-8) is carried by the female ferrule 120. The lock pin 132 is biased to automatically engage the lock hole 104 in the cylindrical portion 98 of the male ferrule 90 when the proximal insertion end 92 of the of the male ferrule is inserted into the proximal end 122 of the female ferrule 120. In particular, the latch 130 is illustrated as having a spring clip 134 (FIG. 8), illustrated as an elongate strip or leaf spring, with a rearward proximal end attached by the fastener 136 to the distal end 126 of the female ferrule 120. A forward distal end portion 138 of the spring clip 134 carries the lock pin 132, and biases the lock pin into a locking position, at which the lock pin is extended through a clearance hole 140 (FIG. 8) through the wall of the tubular proximal end 122 of the female ferrule 120 at a distance 128 from the terminal edge 124. During insertion of the proximal insertion end 92 of the male ferrule 90 into the tubular proximal end 122 of the female ferrule 120, the insertion slope of the tapered tip 94 of the male ferrule 90 encounters the lock pin 132 and moves the lock pin, radially away from the central longitudinal axis of the female ferrule, from its locking position against the force of the spring clip 134.

The lock pin 132, in some embodiments, has an advantageously shaped contact terminus, such as chamfered or rounded, that facilitates sliding along the exterior of the insertion end 92 of the male ferrule 90. For example, a round contact end can allow the pin to ride along the exterior of the tapered tip 94 easily, which makes for a much more efficient and easier experience in use. FIG. 9 is an enlarged side view of a proximal portion of the spring clip 134, indicated by dashed line 9 in FIG. 7. FIG. 9 shows the profile of the lock pin 132, and in particular the rounded contact terminus 142 thereof, according to at least the illustrated advantageous embodiment. The rounded contact terminus 142, shown as hemispherical, facilitates sliding action of the lock pin 134 along the contacted insertion end 92 of the male ferrule 90 during insertion, in particular first contacting and sliding along the along the insertion slope of the tapered tip 94 as the lock pin 132 is displaced from the locking position, and then contacting and sliding along the cylindrical portion 98 as the male ferrule advances toward full insertion. The rounded contact terminus 142 also facilitates the lock pin 132 settling into the lock hole 104. Upon the lock pin 132 reaching the lock hole 104 in the cylindrical portion 98 of the male ferrule, at alignment of the clearance hole 140 and lock hole 104, the spring clip 134 returns the lock pin 132 to the locking position by pressing the lock pin into the lock hole 104 through the clearance hole 140, thereby automatically engaging the lock pin 132 with the lock hole 104 and locking the connection of the ferrules.

The inventive ferrule joint system, including the male ferrule 90, the female ferrule 120, and the automatic latch 130, provides an automatic and releasable engagement between the two mating ferrules (90, 120), without requiring expertise or much force to actuate a connection correctly. Locking and retention are maintained by the spring clip 134, which exerts enough force so the lock pin 132 will not dislodge from the lock hole 104 unintentionally. For use to release the latch, and disjoin the ferrules, the forward distal terminus of the distal end portion 138 of the spring clip is formed as a hook by which the forward end of the spring clip can be pulled radially outward against the bias force thereof thereby disengaging the lock pin 132 from the lock hole 104. By such user action on the hook, the lock pin 132 can be withdrawn from the lock hole 104 and thereby allow the male ferrule 90 to be removed from the female ferrule 120.

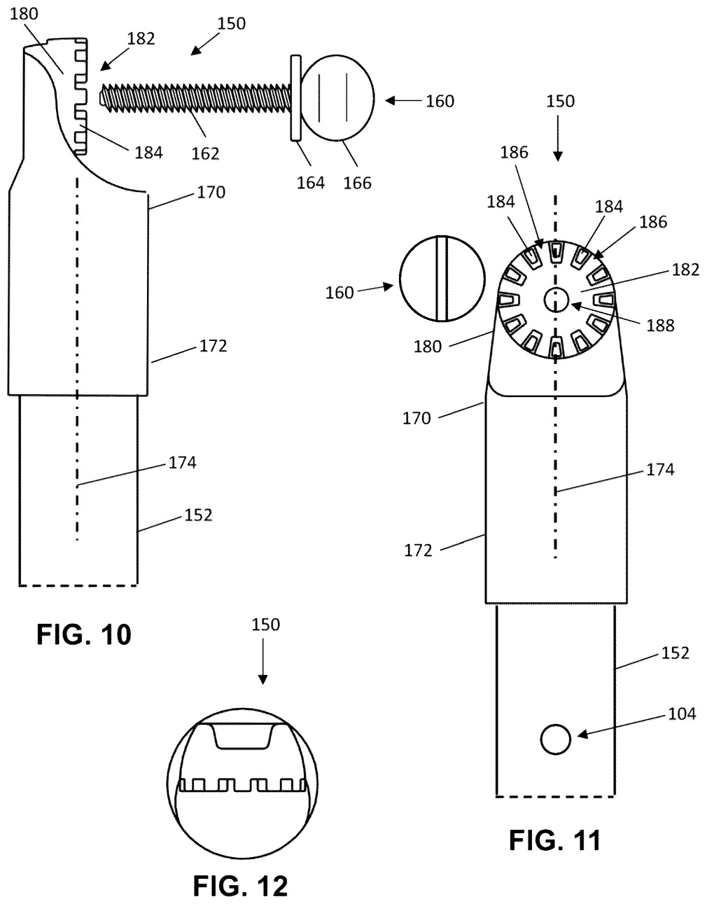

A coupling device 150 is shown in FIGS. 10-12 as having an adapter 170 mounted on a pole section 152. The illustrated adapter 170 has a mounting end 172 and a coupling end 180. The mounting end 172 is illustrated as longitudinally extending circular cylinder that receives or otherwise mounts longitudinally upon the pole section 152. The coupling end 180 has a coupling plate 182 that faces laterally and perpendicularly to the common central longitudinal axis 174 of the mounting end 172 and pole section 152. The adapter 170 in at least one embodiment is fabricated as cast aluminum.

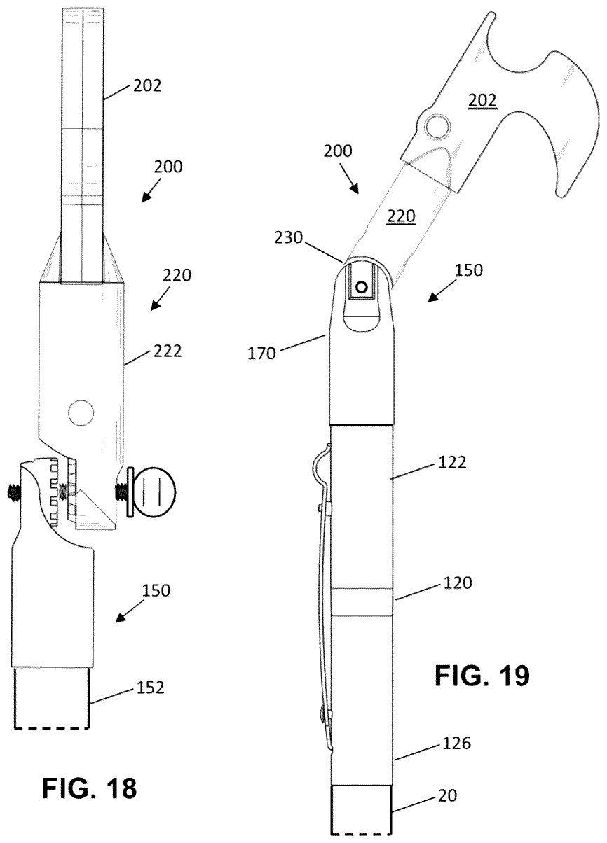

Multiple teeth 184 are raised laterally from the coupling plate 182, defining detents 186 therebetween. The alternating teeth 184 and detents 186 are arranged and uniformly angularly spaced in a circular crown pattern centered around a laterally open fastening hole 188. The coupling plate 182 has a central annular area around the fastening hole 188. The coupling plate 182 is flush with the depths of the detents 186 and sunken relative to the tops of teeth 184. The adapter 170 can couple a tool end or other structure having a matingly corresponding arrangement of teeth and detents, for example as shown in FIGS. 18 and 19.

A threaded fastener 160 is provided to secure such a coupling. The fastener 160 has an externally threaded shank 162 for orienting laterally and aligning with the fastening hole 188. The shank 162 extends from a flange 164, and a handle 166 attached to the flange 164 enables use of the fastener 160 as a thumb screw. The fastening hole 188 is internally threaded to receive and engage the threaded shank 162 to trap a structure mounted thereby between the flange 164 and coupling plate 182. Turning the fastener 160 similarly as a thumb screw tightens and secures a coupling as described below with reference to FIGS. 18-19. The pole section 152 is diametrically dimensioned to slide within the tubular cylindrical end 122 (FIG. 7) of the female ferrule 120, and has a lock hole 104 (FIG. 11) for receiving a fastener such as the lock pin 132 (FIG. 7) of the latch 130 to secure the coupling device 150 to the female ferrule 120 as shown in FIG. 19.

When the female ferrule 120 is mounted on a pole 20 by way of the tubular cylindrical distal end 126, a combined structure such as that illustrated in FIG. 19 is defined by the host pole 20, the female ferrule 120, and coupling device 150, as a long-reach structure having the adapter 170 and coupling end thereof available for coupling to other structures and/or tools by way of the toothed coupling plate. In some uses, the coupling device 150 and/or adapter 170 are mounted on an electrically non-conducting pole, such as a fiberglass composite pole termed a “hotstick” used by utility linemen. This has given rise in industry to the term “hotstick adapter” with reference to the adapter and/or its illustrated mounting on the pole section 152. The coupling device 150 as shown in FIGS. 10-12 may find use in providing cross compatibility between utility linemen equipment, such as hotsticks and their accoutrements, and equipment for arborists.

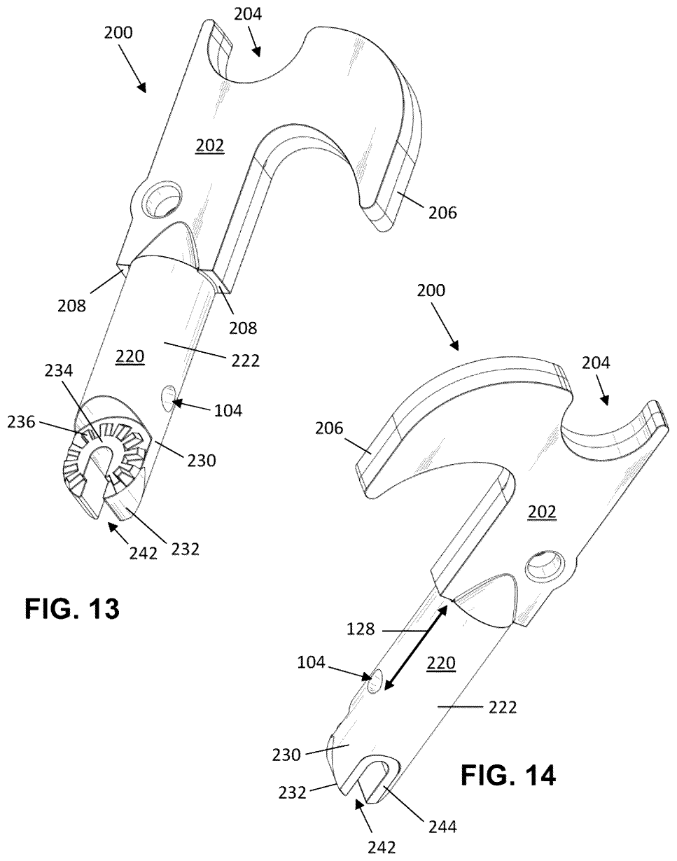

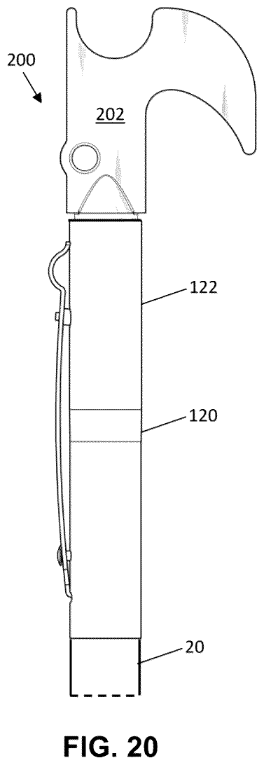

FIGS. 13-17 illustrate a mountable tool 200 having an effector 202 attached to a universal ferrule 220 according to at least one embodiment. The universal ferrule 220 is illustrated as having a cylindrical portion 222 extending from the effector 202 and a coupling end 230 with a rearward terminus 232 opposite the forward effector 202. The universal ferrule 220 has at least two mounting modes as represented by FIGS. 19 and 20.

The mounting mode of FIG. 20 is facilitated by the cylindrical portion 222 having a lock hole 104 formed through and perpendicular to the central longitudinal axis of the cylindrical portion 222. Either open end of the lock hole 104 can receive a fastener, for example, the lock pin 132 (FIG. 7) carried by the female ferrule 120 to thereby mount the mountable tool 200 onto a structure such as a hotstick or other pole.

The mounting mode of FIG. 19 is facilitated by the coupling end 230 having an interrupted coupling annulus 234 extending laterally and perpendicularly relative to the central longitudinal axis of the cylindrical portion 222. Multiple teeth 236, defining detents 238 therebetween, are arranged in a circular arc pattern around the annulus 234. The annulus 234 is flush with the tops of the teeth 236 and raised relative to the detents 238, thus defining a matingly corresponding arrangement with respect to the coupling plate 182 of the adapter 170. The coupling annulus 234 of the universal ferrule 220 is received into the annular space inside the ring of teeth 184 of the adapter 170, and the teeth of the two structures mutually engage, to achieve coupling of the universal ferrule 220 and adapter 170.

A fastening slot 240 extends longitudinally from the forward edge of the terminus 232 to the center of the coupling annulus 234. The coupling annulus 234 of the universal ferrule 220 can be termed as interrupted with respect to a gap 242 defined in the longitudinal end terminus 230 by the open end of the slot 240, which is differentiated from the fastening hole 188, and which interrupts the circular arc pattern of teeth from completing a circle. Each coupling annulus herein described, whether interrupted or completing a circular pattern, in at least one embodiment of each and all, is compatible with the coupling plate 182, their teeth and detents being dimensioned and arranged in compatible patterns for mutual engagement with that of the coupling plate 182.

The gap 242 and slot 240 provide a convenience when mounting the mountable tool 200 to another structure, such as the coupling device 150. The fastener 160 can remain retained by such a fastening hole 188 in a loosened condition (FIG. 18) without potential loss of the fastener during work operations as the mountable tool 200 is placed into a coupling position by sliding the shank of the fastener 160 through the gap 242 and into the slot 240 to the center of the circular arc pattern of teeth and detents. The fastener 160 can then be turned by the handle 166 to tighten and secure the coupling.

The coupling end 230, at a lateral side opposite the interrupted coupling annulus, has a planed area 244 (FIG. 14) defined in an otherwise circular cylindrical form of the coupling end, setting the thickness spanned by a bolt through the slot such as and end bolt of a hotstick. The planed area 244 has a U shape, in plan view, around the slot 240. The planed area provides stable contact and engagement, for example, with the flange 164 of the fastener 160 or with a washer or bolt head when used with other fasteners.

FIG. 19 represents the mountable tool 200 as angularly pivoted at its coupling end 230 relative to the adapter 170 by rotation by hand of the tool to a tentatively preferred angle by a user prior to tightening the fastener. The teeth of the coupling annulus of the mountable tool 200 engaged with the teeth of the coupling plate 182 of the adapter 170 maintain the coupling in an indexed and firm angle. FIG. 19 further represents the coupling device 150 as mounted on the female ferrule 120, which is mounted on, for example, a pole 20 such as a hotstick.

The universal ferrule 220 and coupling end thereof have further advantageous features enabling increased flexibility of use for the mountable tool, and any similar tool having the universal ferrule 220 as illustrated or its equivalent or likeness in function and these described features. The cylindrical portion 222 is diametrically dimensioned to slide within the tubular cylindrical proximal end 122 of the female ferrule 120, and has a lock hole 104, each end of which can receive a fastener such as the lock pin 132 of the latch 130 to secure the universal ferrule 220 and mountable tool to the female ferrule as shown in FIG. 20.

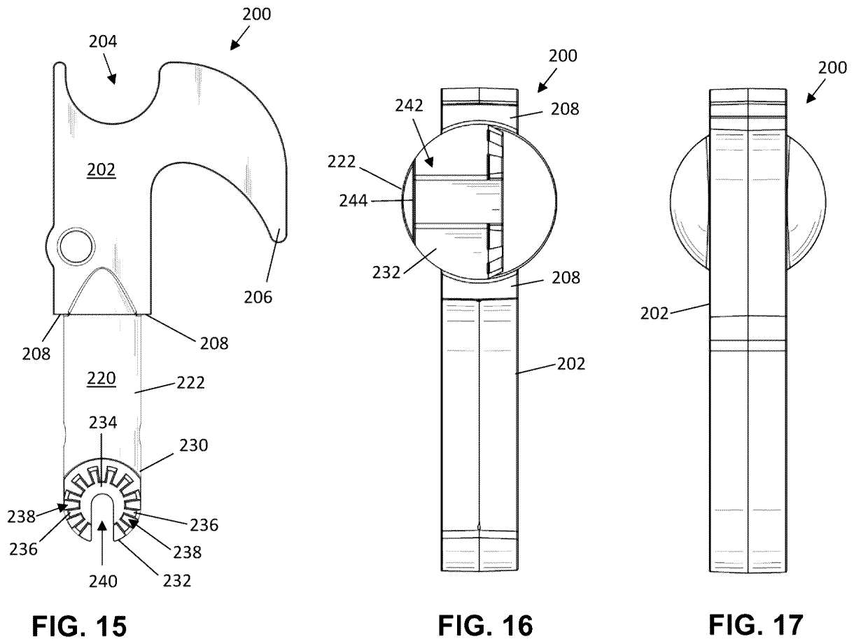

The terminus 232 is effectively tapered by having rounded or circular arc edges along the two sides of the slot 240 viewed in plan view of the annulus 234 (FIG. 15). Either round edge, if properly aligned by a user upon inserting the universal ferrule 220 into the tubular cylindrical end 122 of the female ferrule 120, contacts the rounded lock pin 132 (FIG. 7) to gently and automatically displace the lock pin from its locking position radially outward as the rounded contact terminus 142 (FIG. 9) slides along the exterior of the cylindrical portion 222 until reaching the lock hole 104, where the spring clip 134 automatically returns the lock pin 132 to the locking position thus locking the connection of mountable tool and female ferrule 120 as shown in FIG. 20.

Additionally, the base of the effector 202 connected to the forward end of the cylindrical portion 222 is wider than the diameter of the of the cylindrical portion 222. The base of the effector 202 thus defines an insertion stop 208 intermediate the cylindrical portion 222 and effector 202. The insertion stop 208 is illustrated as a flat surface perpendicular to the cylindrical portion 222. The insertion stop 208 prevents the universal ferrule 220 from being inserted past the alignment plane of the locking pin 132. The lock hole 104 is positioned at approximately the same distance 128 from the insertion stop 208 as that of the clearance hole 140 from the terminal edge 124 of the female ferrule. As a result, alignment of the locking pin 132 and lock hole 104 can be done only in one dimensional adjustment (rotational) once full insertion is achieved by registration of the insertion stop 208 with a terminal proximal edge 124 of the female ferrule 120. This is relatively simple to accomplish because there is a limit to how much the two can be rotated before alignment is achieved (less than a maximum of 360 degrees should align the lock pin with the lock hole).

The effector 202 in the illustrated example of the mountable tool 200 can be characterized as a wire or branch lifter for use in moving and/or removing branches and/or wires from a tree, a power line, a gutter, or wherever needed or preferred. The effector 202 has a forward slot 204 and a reverse hook 206, the use of each of which may vary in the hands of various users. The forward slot 204 may, for example, be used in lifting or pressing elements such as wires, vines, and branches, and the reverse hook 206 can be used for pulling such items. The forward slot 204 aligns with the central longitudinal axis of the cylindrical portion 222, and the reverse hook is offset therefrom.

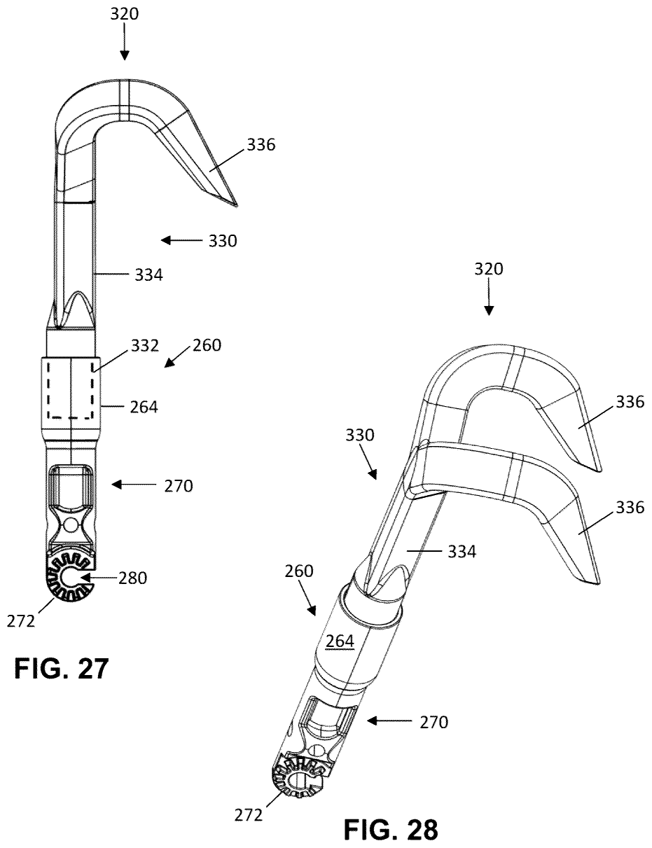

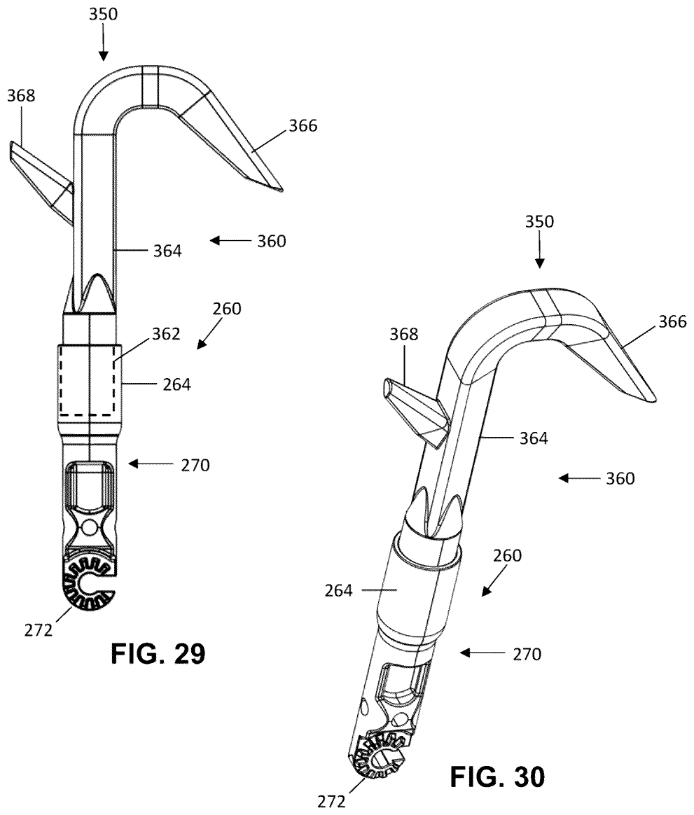

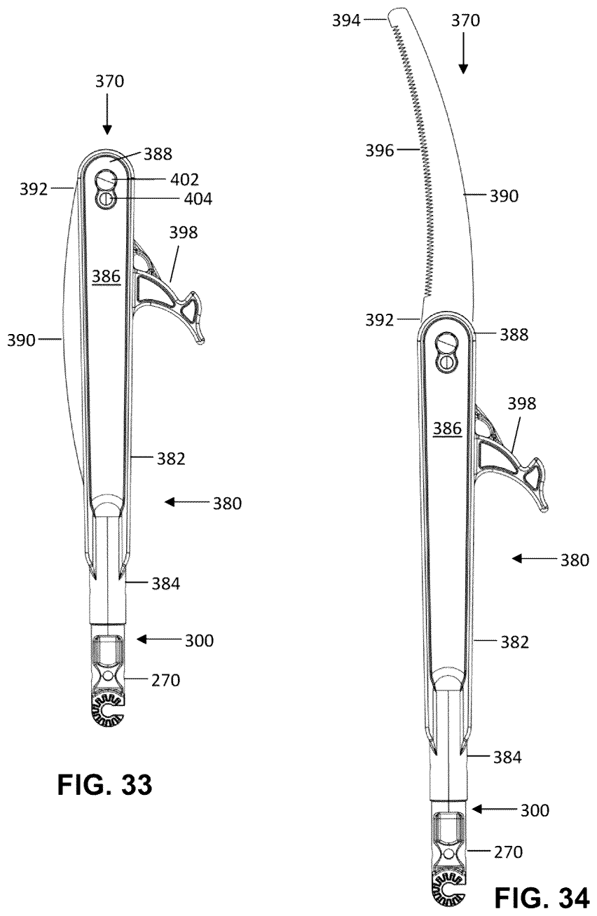

Mountable tools having other effectors are within the scope of these descriptions and drawings, including the double claw effector of FIGS. 27 and 28, the claw and spur effector of FIGS. 29 and 30, and the stowable cutting tool of FIGS. 33 and 34. Other universal ferrules, with and without effectors attached, are as well within the scope of these descriptions.

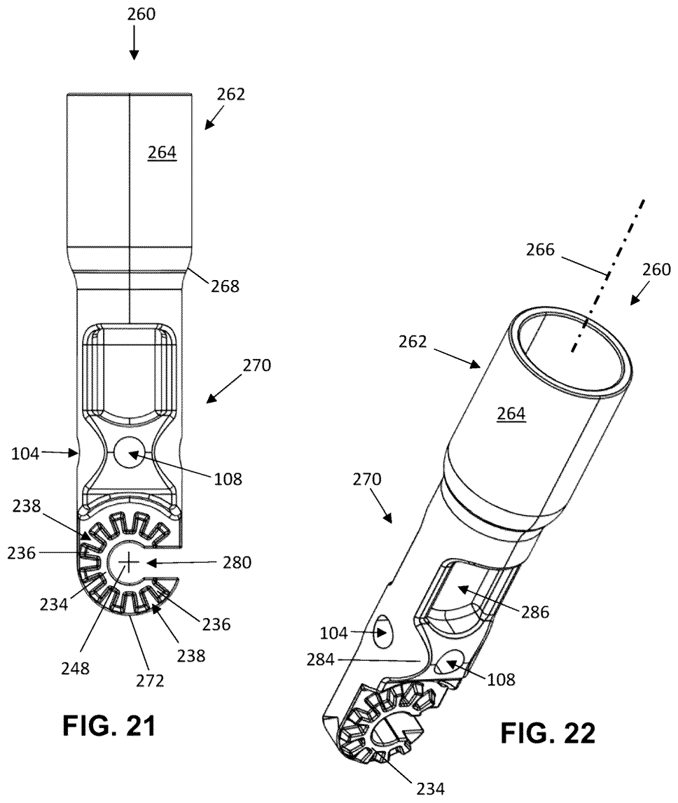

A universal ferrule 260 according to an embodiment shown in FIGS. 21-24 is illustrated as having a mounting end 262 for attaching an effector or other structure, and a coupling end 270 with a terminus 272 opposite the mounting end 262.

A tapered interface 268 connects the mounting end 262 to the coupling end 270, where each is circularly cylindrical proximal the interface 268. In the illustrated universal ferrule 260, the mounting end 262 proximal the interface is diametrically enlarged relative to the coupling end 270 proximal the interface, enabling the insertion of a portion of an effector into the mounting end.

In this example, the mounting end 262 is illustrated as a cylindrical portion 264, which is tubular for receiving therein a matingly configured mounting end of an effector, such as a cylindrical shank portion of an effector or other structure. Non-limiting examples of such effectors are shown in FIGS. 27-30.

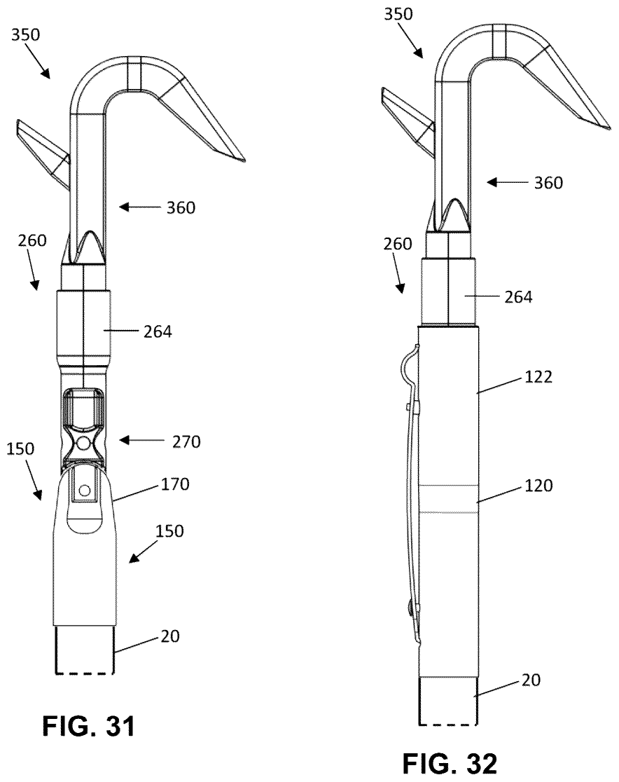

The universal ferrule 260 has at least two mounting modes as represented by FIGS. 31 and 32. The mounting mode of FIG. 31 is facilitated by the coupling end 270 having an interrupted coupling annulus 234 extending laterally and perpendicularly to the central longitudinal axis 266 of the cylindrical portion. The mounting mode of FIG. 32 is facilitated by the insertion of the coupling end 270 into a female ferrule 120.

Similar to the interrupted coupling annulus 234 of the universal ferrule 220 of the mountable tool 200 of FIGS. 13-17, the coupling end 270 of the universal ferrule 260 of FIGS. 21-24 has an interrupted coupling annulus 234 extending laterally and perpendicularly relative to the central longitudinal axis 266 of the cylindrical portion 264. Multiple teeth 236, defining detents 238 therebetween, are arranged in a circular arc pattern around the annulus 234 for engagement with a matingly corresponding arrangement of teeth and detents. The above descriptions of the interrupted coupling annulus 234 of the universal ferrule 220 of the mountable tool 200 of FIGS. 13-17 apply as well to FIGS. 21-24, with an exception that the fastening slot 280 of the universal ferrule 260 extends laterally and perpendicularly from a side edge of the terminus 272 to the central longitudinal axis of the cylindrical portion. Thus, a gap 282 is defined by the slot 280 in the lateral side of the terminus 272 of the coupling end 270. The slot 280 and gap 282 are otherwise similarly functional for permitting the shank of the fastener 160 to reach the center of the coupling annulus 234 to fasten the universal ferrule 260 to a compatible structure such as the adapter 270.

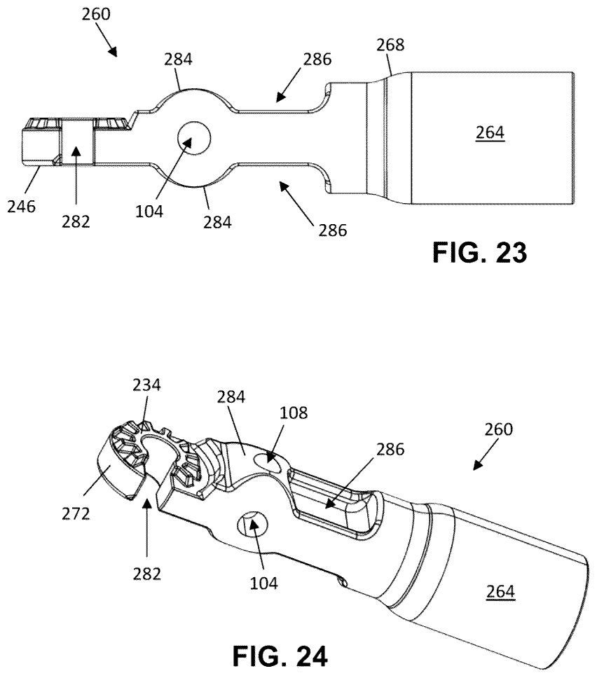

The coupling end 270, at a lateral side opposite the interrupted coupling annulus 234, has a planed area 246 (FIG. 23, 26) around the slot 280. The planed area 246 provides stable contact and engagement, for example, with the flange 164 of the fastener 160 or with a washer or bolt head when used with other fasteners.

The coupling end 270, from the terminus 272 to base of the cylindrical portion 264, defines an insertion end of the universal ferrule 260 when used with a female ferrule 120. The coupling end 270 is dimensioned to slide within the tubular cylindrical proximal end 122 of the female ferrule 120 and has a first lock hole 104 formed through and perpendicular to the central longitudinal axis of the cylindrical portion. Either open end of the lock hole 104 can receive a fastener such as the lock pin 132 of the latch 130 to secure the universal ferrule 260 and mountable tool to the female ferrule 120 as shown in FIG. 20. The terminus 272 is effectively tapered by having a rounded or circular arc forward edge with a uniform radius taken from the center 248 of the annulus 234 to the forward edge, forward of the slot 280, viewed in plan view of the annulus 234 (FIG. 21). The round forward edge of the terminus 272, if properly aligned by a user upon inserting the universal ferrule 260 into the tubular cylindrical end 122 of the female ferrule 120, serves as a guide surface to gently and automatically displace the lock pin 132 radially outward from its locking position as the rounded contact terminus 142 slides along until reaching the lock hole 104, where the spring clip 134 automatically returns the lock pin 132 to the locking position thus locking the connection of universal ferrule 260 and female ferrule 120.

The coupling end 270 defining an insertion end when used with a female ferrule 120 has a second lock hole 108 formed through and perpendicular to the central longitudinal axis 266 of the cylindrical portion 266, and perpendicular to the first lock hole 104. Either open end of the second lock hole 108 can receive a fastener such as the lock pin 132. Between the coupling annulus 234 and cylindrical portion 264, the universal ferrule 260 has opposing bulges 284 serving as guide surfaces to gently and automatically displace the lock pin 132 from its locking position against the force of the spring clip 134 during insertion when the lock pin is at least somewhat aligned with either open end of the second lock hole 108. Upon the lock pin 132 reaching either of the two opposing open ends of the lock hole 108 at the maximum of the respective opposing bulge 284, the spring clip 134 returns the lock pin 132 to the locking position, automatically engaging the two mating ferrules (120, 160).

The coupling end 270 of the universal ferrule 260 shown in FIGS. 21-24 accordingly has four orientations, at the four ends or openings of the two lock holes (104, 108), around the central longitudinal axis 262 of the cylindrical portion 264 for aligning the lock pin with either end of either lock hole (104, 108) and a corresponding guide surface for each to gently and automatically displace the lock pin 132 from its locking position to find an aligned hole end. Each lock hole (104, 108) is defined as a through hole, each having two opposing end openings. In other embodiments, lock hole openings can be formed at the same positions of those illustrated, or other positions, to receive a lock pin whether or not through holes are formed connecting the openings through the host structure.

The universal ferrule 260 has a respective recess 286 (FIG. 21) adjacent to and rearward of each bulge 284. The recesses 286 allow the part to be manufactured easier and with less material for weight savings.

Additionally, the tapered interface 268 (FIG. 21) also serves as an insertion stop, similar to insertion stop 208 of the universal ferrule 220 of the mountable tool 200 of FIGS. 13-17. The lock hole 104 and the lock hole 108 are positioned at approximately the same distance from the interface 268 as that of the clearance hole 140 from the terminal edge 124 of the female ferrule. The tapered interface 268 prevents the universal ferrule 260 from being inserted past the alignment plane of the locking pin 132. As a result, alignment of the locking pin 132 and lock hole 104 can be done only in one dimensional adjustment (rotational) once full insertion is achieved by registration of the tapered interface 268 with a terminal proximal edge 124 of the female ferrule 120.

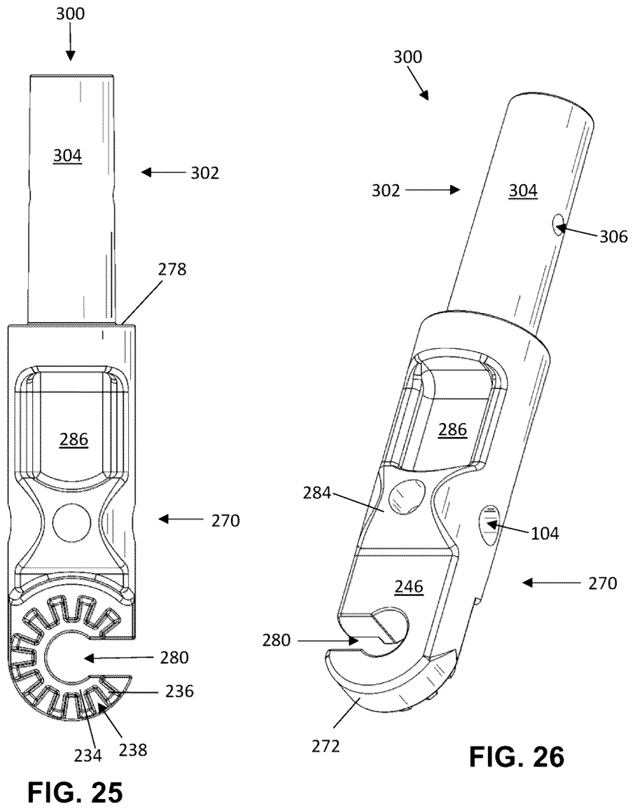

A universal ferrule 300, according to another embodiment, is shown in FIGS. 25-26 as having a mounting end 302 for attaching an effector or other structure, and a coupling end 270 with a terminus 272 opposite the mounting end 302. The coupling end 270 is described in the preceding with reference to FIGS. 21-24. In this example, the mounting end 302 is illustrated as a longitudinally extending tubular cylindrical portion 304 for insertion into a matingly configured mounting end of an effector, an example of which is shown in FIGS. 33-34. A lateral hole 306 (FIG. 26) is illustrated in a side of the cylindrical portion 304 to receive a fastener such as a screw or rivet to retain the universal ferrule 300 upon an effector or other structure.

A step interface 278 connects the mounting end 302 to the coupling end 270, where each is circularly cylindrical proximal the interface 278. In the illustrated universal ferrule 300, the mounting end 302 proximal the interface is diametrically reduced relative to the coupling end 270 proximal the interface, enabling its insertion into a matingly configured mounting end of an effector.

Various embodiments of mountable tools are illustrated in FIGS. 27-34 as various effectors mounted on embodiments of various universal ferrules already described. The mountable tool 320 of FIGS. 27-28 has an effector 330, which is shown as a double claw vine puller, combined with the universal ferrule 260 of FIGS. 21-24. The double claw effector 330 illustrated has a mounting end 332, shown in dashed line in part in FIG. 27 as a cylindrical shank portion inserted into the cylindrical portion 264 of the universal ferrule 260, thereby fixing the effector and ferrule as a unitary implement. A shank extension 334 connected to the inserted mounting end 332 extends forward to a connected pair claws 336, each formed as a reverse hook.

The mountable tool 350 of FIG. 27 has an effector 360, which is shown as a claw and spur vine puller, also combined with the universal ferrule 260 of FIGS. 21-24. The claw and spur effector 360 illustrated has a mounting end 362, shown in dashed line in part in FIG. 29 as a cylindrical shank portion inserted into the cylindrical portion 264 of the universal ferrule 260, thereby fixing the effector and ferrule as a unitary implement. A shank extension 364 connect to the inserted mounting end 362 extends forward to a reverse single hook 366. A spur 368 extends forward from the shank extension in a direction generally opposite the hook.

FIGS. 31 and 32 illustrate two mounting modes achievable by mountable tools within the scope of these descriptions having an effector mounted on a universal ferrule having the coupling end 270 of FIGS. 21-26. In FIG. 31, the mountable tool 350 is mounted on the adapter 150 by way of the coupling annulus 234 (FIGS. 21-22). In FIG. 32, the mountable tool 350 is mounted on the female ferrule 120 by insertion of the coupling end 270 into the tubular cylindrical proximal end 122 of the female ferrule 120.

Mountable tools with yet other effectors are within the scope of these descriptions and drawings. FIGS. 33 and 34 further exemplify a mountable tool 370 having an effector mounted on the universal ferrule 300 of FIGS. 25-26 having the coupling end 270 of FIGS. 21-26. The effector of FIGS. 33 and 34 is shown as a stowable cutting tool 380 combined with the universal ferrule 300 of FIGS. 25-26. The mountable tool 370 can thus achieve the two mounting modes represented in FIGS. 31 and 32.

The stowable cutting tool 380 has a handle assembly 382 with a rearward extension 384 that receives the mounting end 302 of the universal ferrule 300 (FIGS. 25-25). A scabbard section 386 of the handle assembly extends forward from the rearward extension 384 to a distal end 388. The scabbard section 386 defines a longitudinally extending linear slot for receiving a blade 390 in a stowed and safe manner (FIG. 33). The rearward extension 384, together with the rearward extending coupling end 270 of the universal ferrule form an actual handle. A user can grab the tool in this portion and use the tool as a hand tool without the need for attaching it to a pole.

The blade 390 has a pivotally mounted first end 393, a second end 394 opposite the first end, and a toothed cutting edge 396 extending from the first end 392 toward the second end 394. The first end 392 is pivotally mounted on the distal end 388 of the handle assembly such that the second end 394 travels in an arc upon pivoting the blade 390 around the first end 392. A range of rotational travel of the blade 390 is defined between a folded configuration of the cutting tool 370 (FIG. 33), in which at least the cutting edge 396 is received longitudinally by the extending linear slot of the scabbard section 380 and an extended configuration of the cutting tool (FIG. 34), in which the blade 390 extends at least partially forward from the handle assembly with the cutting edge 396 removed from the scabbard section and exposed for use. The mountable cutting tool 370 is useful separate from a pole or other accessory. Some features, for example the limb hook 398, may be of particularly advantage when the cutting tool 370 is mounted on an accessory such as a pole.

The first end 392 of the blade 390 is pivotally attached to the distal and by a pivot fastener 402, and is permitted to transition between the folded and extended configurations by a stop member having a head 404, which serves as a button for manual displacement of the stop member from a blade-locked position into which the stop member is pressed by a compression spring whenever either the completely folded and completely extended configuration is reached, locking the blade in its current position.

The above devices, tools, ferrules, fasteners, and other items together and in various combinations, those combinations expressly illustrated and all other combinations enabled by features described and/or illustrated, constitute a modular product line with high interoperability and multifunction capabilities. The elements described and/or illustrated can implemented in many materials, including plastic and metal, depending on preferences of users and makers, which may vary with applications of use.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A male ferrule comprising:
a mounting end comprising a cylindrical portion for receiving an effector, the cylindrical portion defining a central longitudinal axis;
a coupling end opposite the mounting end, the coupling end comprising:
a coupling annulus extending perpendicularly to the longitudinal axis;
multiple teeth, defining detents therebetween, arranged in a circular arc at least partially around the coupling annulus; and
a lock hole for receiving a fastener,
wherein the coupling end is configured to be inserted in a female ferrule with a lock pin of the female ferrule received in the lock hole, and
wherein the coupling annulus and multiple teeth are configured to mount on a hotstick adapter for use with a hotstick.

2. The male ferrule according to claim 1, wherein the coupling annulus is flush with tops of the multiple teeth.

3. The male ferrule according to claim 1, wherein:
the coupling end comprises a terminus opposite the mounting end; and
the coupling annulus is interrupted by a slot extending from an edge of the terminus to a center of the coupling annulus.

4. The male ferrule according to claim 3, wherein the slot extends longitudinally.

5. The male ferrule according to claim 3, wherein the slot is perpendicular to the longitudinal axis.

6. The male ferrule according to claim 3, wherein the terminus comprises a round forward edge with a uniform radius taken from a center of the coupling annulus to the forward edge.

7. The male ferrule according to claim 1, further comprising:
a first bulge on a first side of the male ferrule between the coupling annulus and the cylindrical portion of the mounting end;
a first lock hole opening at a maximum of the first bulge;
a second bulge on a second side of the male ferrule opposite the first side and between the coupling annulus and the cylindrical portion of the mounting end; and
a second lock hole opening at a maximum of the second bulge.

8. The male ferrule according to claim 1, further comprising an interface connecting the mounting end to the coupling end, wherein the interface is enlarged relative to the coupling end such that the interface serves as an insertion stop when the coupling end is inserted into a female ferrule.

9. The male ferrule according to claim 1, wherein:
the mounting end is circularly cylindrical at an interface connecting the mounting end to the coupling end; and
the coupling end is circularly cylindrical at the interface.

10. The male ferrule according to claim 9, wherein the mounting end proximal the interface is diametrically enlarged relative to the coupling end proximal the interface, enabling the insertion of a portion of an effector into the mounting end.

11. The male ferrule according to claim 9, wherein the mounting end proximal the interface is diametrically reduced relative to the coupling end proximal the interface, enabling insertion of the mounting end into a portion of an effector.

12. The male ferrule according to claim 1, wherein the coupling end comprises a planed area around the slot on a lateral side opposite the coupling annulus.

13. The male ferrule according to claim 1, wherein an effector is mounted on the mounting end by way of the cylindrical portion, the effector comprising at least one hook.

14. The male ferrule according to claim 1, wherein an effector is mounted on the mounting end by way of the cylindrical portion, the effector comprising at least one toothed cutting edge.

15. A mountable tool comprising:
a male ferrule comprising:
a mounting end defining a central longitudinal axis;
a coupling end opposite the mounting end, the coupling end comprising:
a coupling annulus extending perpendicularly to the longitudinal axis;
multiple teeth, defining detents therebetween, arranged in a circular arc at least partially around the coupling annulus; and
a lock hole for receiving a fastener; and
an effector mounted on the mounting end of the male ferrule,
wherein the coupling end is configured to be inserted in a female ferrule with a lock pin of the female ferrule received in the lock hole, and
wherein the coupling annulus and multiple teeth are configured to mount on a hotstick adapter for use with a hotstick.

16. The mountable tool of claim 15, wherein the effector comprises at least one hook.

17. The mountable tool of claim 15, wherein the effector comprises at least one toothed cutting edge.

18. The mountable tool of claim 15, wherein:
the coupling end of the male ferrule comprises a terminus opposite the mounting end; and
the coupling annulus is interrupted by a slot extending from an edge of the terminus to a center of the coupling annulus.

19. The mountable tool of claim 18, wherein the terminus comprises a round forward edge with a uniform radius taken from a center of the coupling annulus to the forward edge.

20. The mountable tool of claim 15, wherein the male ferrule further comprises:
a first bulge on a first side of the male ferrule between the coupling annulus and the mounting end;
a first lock hole opening at a maximum of the first bulge;
a second bulge on a second side of the male ferrule opposite the first side and between the coupling annulus and the mounting end; and
a second lock hole opening at a maximum of the second bulge.

21. The mountable tool of claim 15, wherein:
an interface of the effector is mounted on a cylindrical portion the coupling end of the male ferrule;
the interface of the effector is wider than a diameter of the of the cylindrical portion of the coupling end of the male ferrule such that the interface serves as an insertion stop when the coupling end is inserted into a female ferrule.
